(19) United States
(12) Patent Application Publication
(10) Pub. No.: US 2008/0198391 A1
(43) Pub. Date: Aug. 21, 2008

(54) IMAGE FORMING APPARATUS, COLOR CONVERSION METHOD AND COLOR CONVERSION PROGRAM

(75) Inventor: Yuusuke Suzuki, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/676,335

(22) Filed: Feb. 19, 2007

(51) Int. Cl. G06K 15/00

(52) U.S. Cl. 358/1.9

(57) ABSTRACT

To provide a technique that enables high-quality image forming processing regardless of the type of a color space in which colors of image data are represented without increasing a processing burden markedly.

An image forming apparatus formed by including: a color space determination unit 201 configured to determine in which one of plural specific color spaces in representation systems different from one another colors of image data to be subjected to image forming processing are represented; a color space setting unit 202 configured to set the color space determined by the color space determination unit 201 as a device color space of image data inputted into the image forming apparatus; and a color conversion unit 203 configured to convert the colors of the image data to be subjected to the image forming processing to colors represented in a color space used for color representation with a developing agent in the image forming processing according to the color space set as the device color space by the color space setting unit 202.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to an image forming apparatus, and more particularly, to color conversion processing according to image data.

2. Description of the Related Art

Recently, the required quality for image forming processing according to color image data has been increasing due to a widespread use of a high-definition color display or printer. Along with such a requirement, color data handled inside the OS is now being processed in a color space achieving color reproducibility better than before.

However, the inability of the printer to support a data length or the gamut of the color space achieving such excellent color reproducibility makes it impossible to perform high-quality print processing utilizing high-definition color image data processed inside the OS.

The invention was devised to solve the problem discussed above, and has an advantage to provide a technique for enabling high-quality image forming processing regardless of the type of color space in which colors of image data are represented without increasing a processing burden markedly.

### DESCRIPTION OF THE DRAWINGS

FIG. 1 is a network configuration view schematically showing the configuration of a network system including an image forming apparatus according to a first embodiment of the invention;

FIG. 2 is a view used to describe the configuration of the image forming apparatus according to the first embodiment of the invention;

FIG. 3 is a flowchart showing the processing in an image forming program of the embodiment;

FIG. 4 is functional block diagram used to describe an image forming apparatus M of the embodiment;

FIG. 5 is a flowchart used to describe the flow of processing (color conversion method) in the image forming apparatus of the embodiment;

FIG. 6 is a flowchart used to describe the flow of color conversion processing in an image forming apparatus according to a second embodiment of the invention;

FIG. 7 is a flowchart used to describe the flow of color conversion processing in an image forming apparatus according to a third embodiment of the invention;

FIG. 8 is a flowchart used to describe the flow of color conversion processing in an image forming apparatus according to the third embodiment of the invention;

FIG. 9 is a flowchart used to describe the flow of color conversion processing in an image forming apparatus according to a fifth embodiment of the invention;

FIG. 10 is a flowchart used to describe the flow of color conversion processing in an image forming apparatus according to a sixth embodiment of the invention;

FIG. 11 is a flowchart used to describe the flow of color conversion processing in an image forming apparatus according to the sixth embodiment of the invention;

FIG. 12 is a view showing a method for setting a color space to PDL data by a color space setting unit; and

FIG. 13 is a view showing a method for setting a color space to PDL data by a color space setting unit.

### DETAILED DESCRIPTION OF THE INVENTION

Hereinafter, embodiments of the invention will be described with reference to the drawings.

Throughout this description, the embodiments and examples shown should be considered as exemplars, rather than limitations on the apparatus, methods and programs of the present invention.

### First Embodiment

A first embodiment of the invention will be described first. This embodiment shows, as an example, a color conversion technique relating to printing of a document including an object whose drawing colors are specified by device-dependent colors, DeviceRGB, DeviceGray, and DeviceCMYK, in an image forming apparatus capable of receiving and printing PDL data in compliance with the PostScript (registered trademark) language specification.

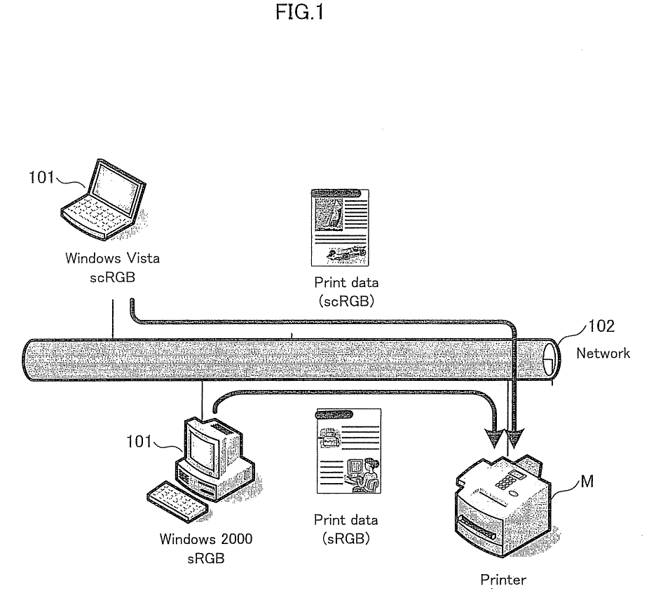

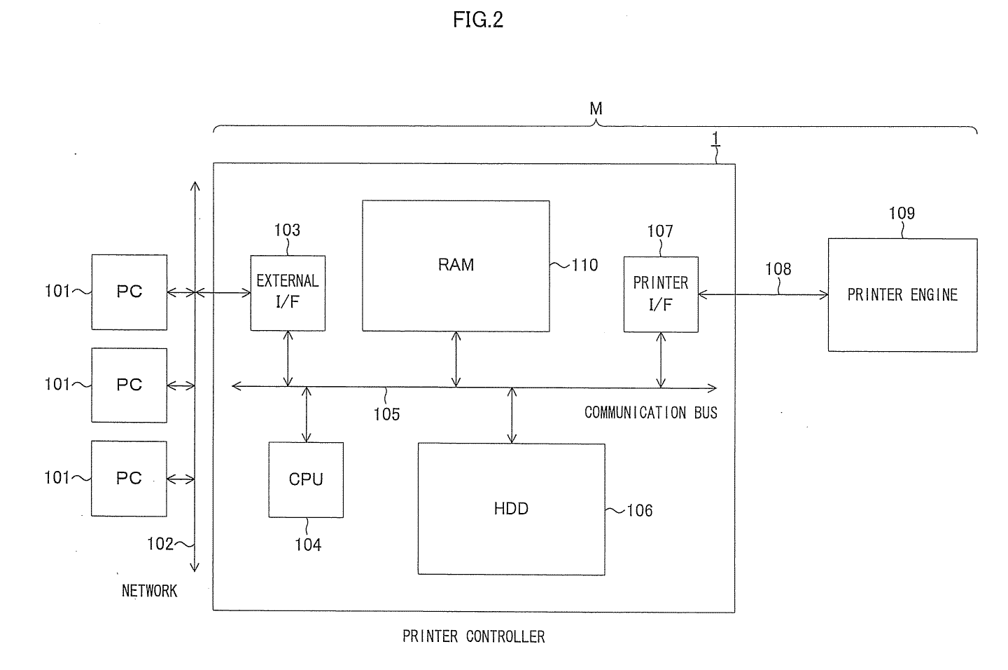

FIG. 1 is a network configuration view schematically showing the configuration of a network system including an image forming apparatus according to the first embodiment of the invention. FIG. 2 is a view used to describe the configuration of the image forming apparatus according to the first embodiment of the invention.

Referring to the configuration view of FIG. 2, when the user gives an instruction to execute printing, print information is transmitted from a PC 101 to a printer controller 1. The printer controller 1 converts the print information received from the PC 101 to print image data, and transmits a print image thus converted to a printer engine 109. The printer engine 109 receives the print image data, and outputs it by forming it on a print medium. Communications between the PC 101 and the printer controller 1 are made via a network 102, and communications between the printer controller 1 and the printer engine 109 are made by a communication channel 108 capable of achieving high-speed data transmissions. In this embodiment, a printer (image forming apparatus) M is configured so as to be able to perform print processing according to print instructions from plural PC's 101. On the plural PC's 101, the OS of any of WindowsVista (registered trademark), WindowsXP (registered trademark), Windows2000 (registered trademark), and Windows98 (registered trademark) is operating, and an application program or the printer driver is operating on the OS. With WindowsXP, Windows2000, and Windows98, color data is handled by “sRGB color space” inside the OS. Meanwhile, with WindowsVista, color data is handled inside the OS by a color space referred to as “scRGB color space” that has a longer bit length and a wider gamut than those of the sRGB color space.

The printer controller 1 shown in FIG. 2 receives PDL data, fonts registered in the printer controller 1, a PDL macro, color conversion table data, and so forth supplied from the PC's or the like, and forms a print image corresponding to an input content and stores the fonts, the macro, and the color conversion table data into the internal memory region according to the PJL attached for control and the content of the PDL description.

The PC 101 is connected to the network 102 to which the printer controller 1 is connected, and is therefore able to make communications with the printer controller 1 via the network 102. When a printing instruction is given by an operation of the user, the printer driver 1 describes the print content in PDL, and the OS on the PC 101 transmits the PDL data to the printer controller 1 over the network. A print data communication protocol is used for transmissions of the PDL data, and data is transmitted under the transmission control according to the protocol. There may be a case where the user directly describes PDL data or a case where the application generates PDL data by bypassing the printer driver. In these cases, too, as with the case of using the printer driver, the PDL data is transmitted to the printer controller by following the transmission procedure according to the print data communication protocol by the application for PDL data transmissions and the capability the OS provides. These plural PC's are independently connected to the network 102, and are able to transmit PDL data to the printer controller 1 by the same scheme as described above.

The network 102 is formed of network devices, such as a cable, a router, a gateway, a hub, and a radio router, and enables communications among the devices linked thereto. The PC's 101 and the printer controller 1 are connected to the network 102 by a cable or a radio LAN connection device so as to enable mutual communications.

The printer controller 1 receives PDL data sent from the PC 101, converts the data to a print image, and transmits the print image to the printer engine 109. Processing relating to this print image forming processing is achieved by a program that is run in the inside. In the inside, the printer controller 1 has an external I/F 103 that enables communications with the PC's 101 and a printer I/F 107 that enables communications with the printer engine 109. A program that is run inside the printer makes communications using these I/F's via the device driver that controls these I/F's.

The printer controller 1 is formed of a CPU 104, a RAM 110, an HDD (hard disc) 106, the external I/F 103, the printer I/F 107, and a communication bus 105. The respective components are connected to the communication bus and are therefore able to make communications with the CPU 104. Also, it is possible to make data communications with devices other than the RAM 110 and the CPU 104 by the DMA (Direct Memory Access) communication method by bypassing the CPU 104. The CPU 104 runs a program that performs processing relating to printing. The RAM 110 stores the program relating to print processing, PDL data, a print image, font data, and work data while the program is run. Part of the RAM region serves as a non-volatile RAM called an NVRAM, and data is saved after the power supply is switched OFF for the setting information or the like relating to printing and unique to the printer to be stored therein. In the HDD 106, the received PDL data, the resident fonts, a conversion table relating to color conversion, and data describing coefficients, and so forth are stored. The PDL data is stored in the HDD 106 by a program running on the printer controller called spooler, which makes it possible to achieve an efficient use of the CPU 104. The communication bus enables data communications between the CPU 104 and other components within the printer controller and between the RAM 110 and the components within the printer controller other than the CPU 104. A program called a device driver that controls the external I/F 103 and the printer I/F 107 is resident on the RAM 110, and when the program relating to print processing makes communications with the network or communications with the printer engine, the processing is performed through this program. The device driver controls the external I/F 103 and the printer I/F 107, makes communications with the original program by calling the device driver, and enables data transmissions and receptions with the respective I/F's. Accordingly, communications with the PC of the program running inside the printer controller and the printer engine are achieved.

The printer engine 109 makes communications with the printer controller via the communication channel 108 with the printer controller to receive a print image from the printer controller 1, and print-outputs the print image in color on a print medium, such as paper, using toner particles in cyan, magenta, yellow, and black.

Hereinafter, program processing (color conversion method) by the printer controller 1 in the image forming apparatus M of this embodiment will be described. The program is stored in the HDD 106 and is run by being loaded on the RAM 110 at the time of start-up of the printer controller 1. The program includes a control program, a spooler program, and an image forming program. The control program is constantly activated and receives print data and calls out other programs to achieve the processing in the printer controller 1. The control program calls out the spooler program when PDL data is sent from the PC 101 via the network 102 to let the PDL data be spooled to the hard disc 106. When the PDL data is stored in the hard disc 106 by the spooler program, the control program calls out the image forming program and subjects the spooled PDL data to image forming processing. After a print image is formed, the print image is transmitted to the printer engine 109 via the printer I/F 107.

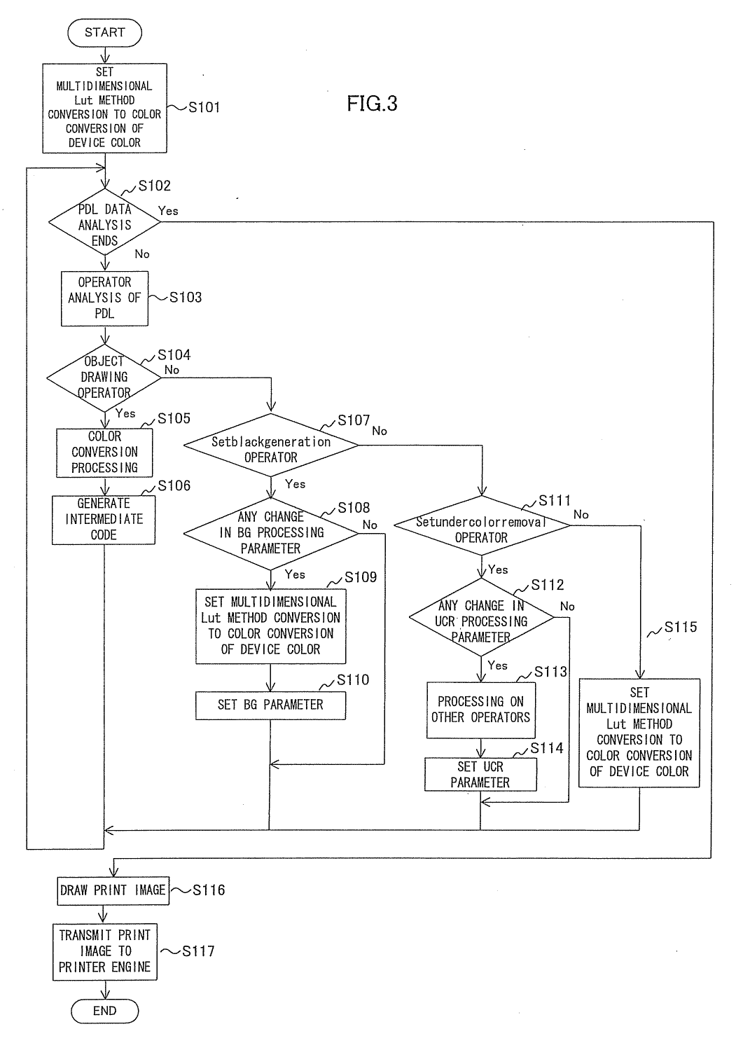

FIG. 3 is a flowchart showing the processing of the image forming program of this embodiment. For the color conversion in the image forming processing, either of the color conversion methods, polynomial color conversion in compliance with PS and multidimensional Lut (look-up table) color conversion, can be used selectively as the color conversion of the device color. In the processing flow of the image forming processing, the multidimensional Lut color conversion is set first as the color conversion of the device color (S101). Subsequently, whether all the PDL data to be printed has been subjected to analysis processing is determined (S102). In a case where the analysis is found not to have been completed from the determination, the described operator is analyzed by processing the PDL data (the step of determining the color space) (S103). Whether the operator analyzed herein is an operator that supports the drawing of a text, a graphic, an image, and so forth is determined (S104). When the operator is a drawing operator and the device color, colors are determined using the color conversion being set (the step of setting the color space, the step of converting colors) (S105), and an intermediate code is generated (S106). In a case where the operator is not a drawing operator, whether it is a setblackoverprint operator is determined (S107). When it is a setblackoverprint operator, whether a parameter of blackgeneration processing having been set changes due to this operator is determined (S108). In a case where it is determined that the parameter of the blackGeneration processing changes, polynomial color conversion is set to the color conversion processing of the device color (S109), and a parameter specified by the operator is set (S110). In a case where it is determined that the parameter of the blackgeneration processing does not change, the processing is returned to the PDL data analysis processing end determination. Also, in a case where it is determined that the operator is not the setblackgeneration operator, whether the analyzed operator is a setundercolorremoval is determined (S111). In a case where it is the setundercolorremoval operator, whether a parameter of UCR processing changes due to the instruction by this operator is determined (S112). Herein, when it is determined that the parameter changes, the polynomial color conversion is set to the color conversion processing of the device color (S113). The parameter specified by the operator is then set to the UCR processing (S114). In a case where it is determined that the operator is not the setundercolorremoval operator, either, processing corresponding to the respective operators is performed (S115). The processing described as above is repeated until all the PDL data has been analyzed. When the analysis processing of the PDL data ends, the print image is subjected to forming processing by utilizing the intermediate code generated in the analyzing processing (S116). The image thus formed is transmitted to the printer engine so as to be print-outputted (S117).

According to the processing of this embodiment as has been described, it is possible to perform print processing of a device color object at a high speed in colors more appropriate for the image forming apparatus in the data printing in the PostScript format.

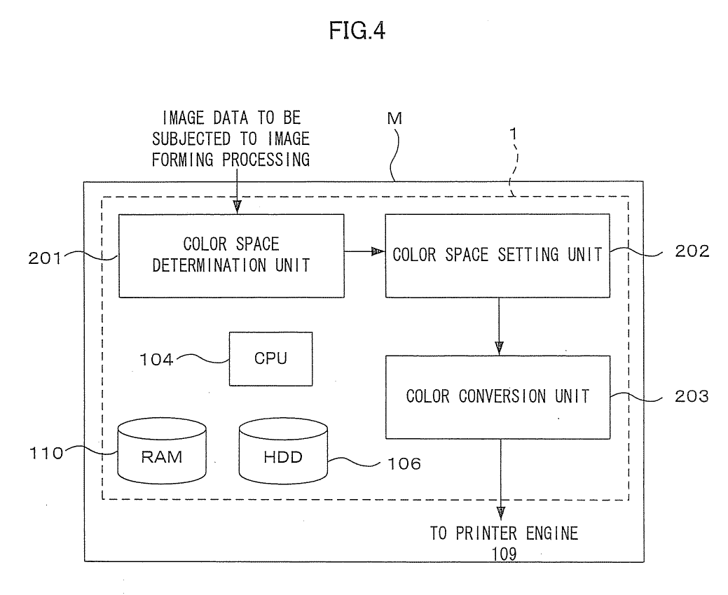

FIG. 4 is a functional block diagram used to describe the image forming apparatus M of this embodiment. Herein, the printer controller 1 is formed of a color space determination unit 201, a color space setting unit 202, a color conversion unit 203, the CPU 104, the HDD 106, and the RAM 110.

The color space determination portion 201 determines in which one of plural specific color spaces in the representation systems different from one another the colors of image data to be subjected to the image forming processing are represented.

The color space setting unit 202 sets the color space determined by the color space determination unit 201 as the device color space of image data inputted to the image forming apparatus. Herein, the device color space is DeviceRGB dependent on the device used to input image data to the image forming apparatus, and plural specific color spaces include at least sRGB and scRGB.

Also, the color space setting unit 202 appends information about the color space determined by the color space determination unit 201 to the page description language data based on the image data to be subjected to the image forming processing to set this color space as the device color space of the image data inputted into the image forming apparatus. The color space setting unit 202 also appends a color conversion look-up table used to convert colors represented in the color space determined by the color space determination unit 201 to colors represented in the color space used for color representation with a developing agent in the image forming processing to a comment portion of the page description language data based on the image data to be subjected to the image forming processing.

In addition to the above, the color space setting unit 202 is also able to set the drawing colors of the page description language data based on the image data to be subjected to the image forming processing to the representation system by the color space determined by the color space determination unit 201.

The color conversion unit 203 converts colors of the image data to be subjected to the image forming processing to colors represented in the CMYK color space used for the color representation with a developing agent in the image forming processing by the image forming apparatus M according to the color space set as the device color space by the color space setting unit 202.

The color conversion unit 203 converts the colors of the image data to be subjected to the image forming processing to colors represented in the color space used for the color representation with a developing agent in the image forming processing according to the color conversion look-up table appended to the comment portion of the page description language data based on the image data to be subjected to the image forming processing by the color space setting unit 202. The color conversion unit 203 converts colors of the image data to be subjected to the image forming processing to colors represented in the color space used for the color representation with a developing agent in the image forming processing with reference to the multidimensional look-up table or a conversion matrix corresponding to the color space set as the device color space by the color space setting unit 202.

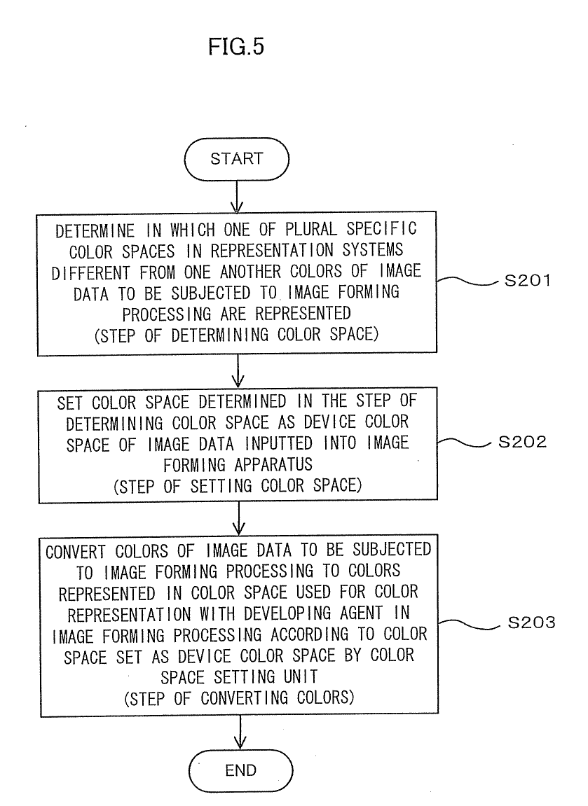

FIG. 5 is a flowchart used to describe the flow of the processing (color conversion method) by the image forming apparatus of this embodiment.

The color space determination unit 201 determines in which one of plural specific color spaces in the representation systems different from one another colors of the image data to be subjected to the image forming processing are represented (the step of determining the color space) (S201).

The color space setting unit 202 sets the color space determined in the step of determining the color space as the device color space of the image data inputted into the image forming apparatus (the step of setting the color space) (S202). Herein, the device color space is DeviceRGB dependent on the device that inputs the image data into the image forming apparatus, and the plural specific color spaces include at least sRGB and scRGB.

The color conversion unit 203 converts colors of the image data to be subjected to the image forming processing to colors represented in the color space used for the color representation with a developing agent in the image forming processing according to the color space set as the device color space by the color space setting unit (the step of converting colors) (S203).

Each of the steps in the processing by the image forming apparatus described above can be achieved by running the color conversion program stored in the HDD 106 or the RAM 110 on the CPU 104.

### Second Embodiment

A second embodiment of the invention will now be described.

An image forming apparatus according to the second embodiment of the invention is characterized in that a table of the multidimensional Lut color conversion of the device color is read in the data format of the PostScript format.

The configuration of this embodiment is the same as that of the first embodiment except that part of the processing in the image forming processing is different. In the image forming processing flow, the color conversion processing of the device color per se using the multidimensional Lut is the same as that of the first embodiment, and the processing to read in the multidimensional Lut is different.

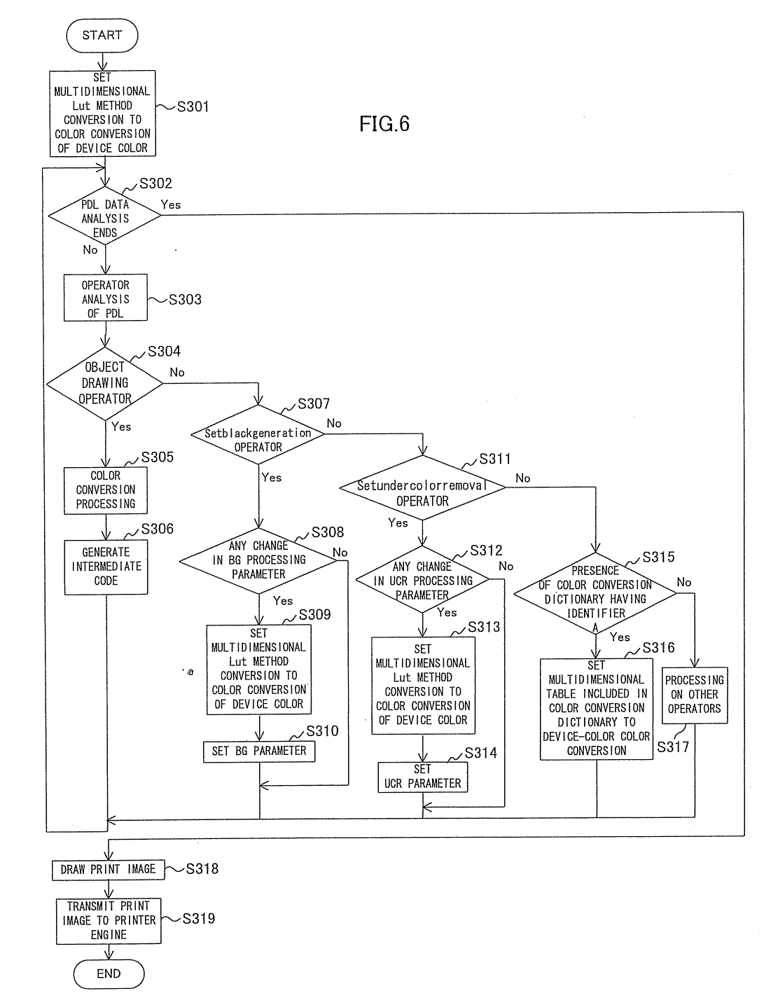

FIG. 6 is a flowchart used to describe the flow of the color conversion processing in the image forming apparatus of this embodiment. Hereinafter, descriptions will be given by focusing particularly on the read-in of the multidimensional Lut. In the flowchart of the drawing, because the processing in S301 and S302, S304 through S314, and S317 through S319 is the same as the processing in S101 and S102, S104 through S114, and S115 through S117 in the first embodiment above, descriptions are omitted herein.

Referring to the flowchart shown in FIG. 6, the color space determination unit 201 performs operator analysis of the PDL data (S303), and determines whether the operator is the one to which a special identifier A (for example, ToshibaCRDNo123) is appended to define color conversion dictionary data (S315). In a case where the determination result is true, the color space setting unit 202 reads in the data as the table used for the multidimensional Lut color conversion of the device color from this color conversion dictionary (the step of setting the color space) (S316).

More specifically, in the analysis processing of PDL data described in the CRD format in the PostScript language specification with the special identifier being appended to the multidimensional color conversion Lut, the CRD data to which the special identifier is appended is set as the color conversion table used in the color conversion processing according to the multidimensional Lut.

By the color conversion of the device color in the second embodiment, not only is it possible to print the device color included in the document in colors appropriate to the image forming apparatus, but it is also possible to reflect the multidimensional Lut in which the colors are customized on the image formation. Also, the PDL involved in this image formation can be printed by an image forming apparatus that supports PostScript without causing any error.

As has been described, in the step of setting the color space in this embodiment, by appending information about the color space determined in the step of determining the color space to the page description data based on the image data to be subjected to the image forming processing, it is possible to set this color space as the device color space of the image data inputted into the image forming apparatus.

### Third Embodiment

A third embodiment of the invention will now be described.

An image forming apparatus of the third embodiment is characterized in that the table of the multidimensional Lut color conversion of the device color is read in from the comment portion of the PDL in the PostScript format.

The configuration of this embodiment is the same as that of the first embodiment except that part of processing in the image forming processing is different. In the image forming processing flow, the color conversion processing of the device color per se using the multidimensional Lut is the same as that of the first embodiment, and the processing to read in the multidimensional Lut is different.

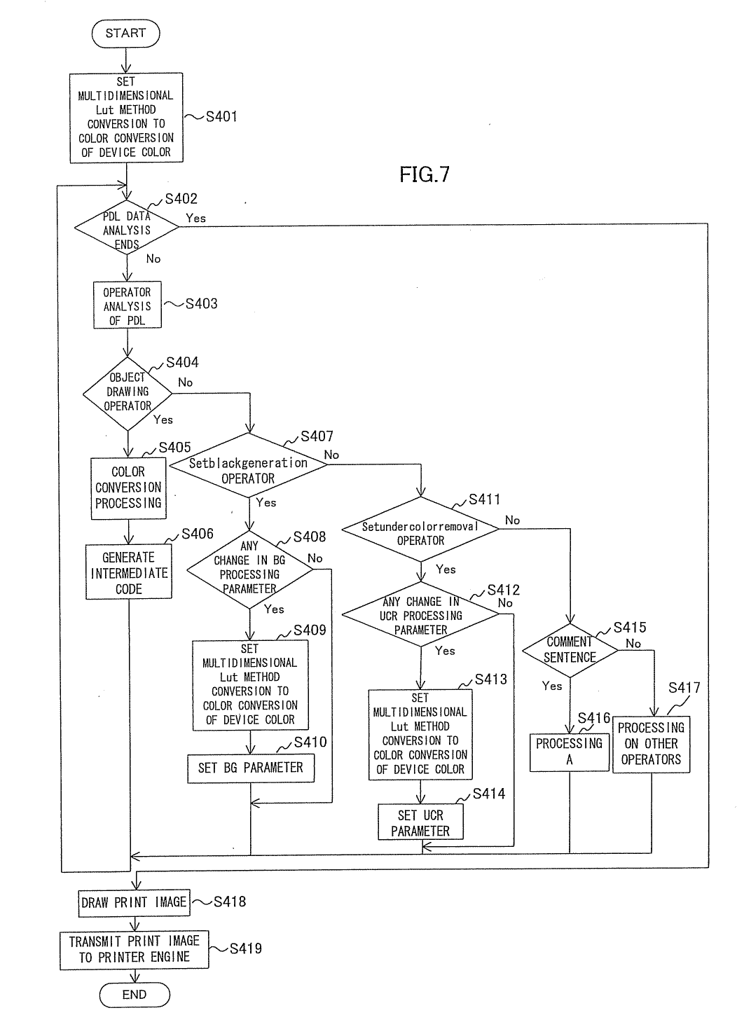

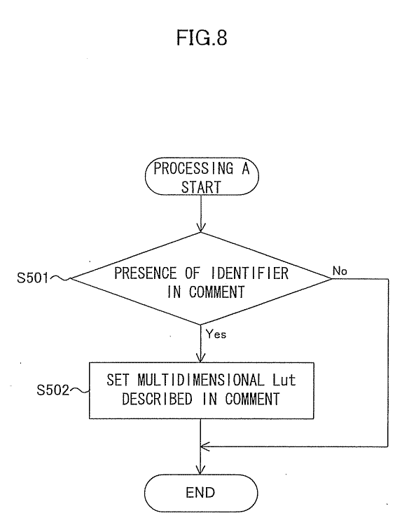

FIG. 7 and FIG. 8 are flowcharts used to describe the flow of the color conversion processing by the image forming apparatus of this embodiment. Hereinafter, descriptions will be given by focusing particularly on the read-in of the multidimensional Lut. In the flowchart shown in FIG. 7, because the processing in S401 and S402, S404 through S414, and S417 through S419 is the same as the processing in S101 and S102, S104 through S114, and S115 through S117 in the first embodiment above, descriptions are omitted herein.

In the processing flow, the color space determination unit 201 performs operator analysis of PDL data (S403) and determines that the subject of the processing is a comment sentence (S415). Upon determination as being a comment sentence, the color space determination unit 201 determines whether there is a special identifier indicating the presence of the multidimensional Lut in the comment portion (S501). Herein, in a case where it is determined that the identifier is present, the color space setting unit 202 reads in the multidimensional Lut described in the comment portion, and sets it as the multidimensional Lut color conversion table of the device color (S502).

The color space setting unit 202 in this embodiment appends the color conversion look-up table used to convert the colors represented in the color space determined in the step of determining the color space to colors represented in the color space used for the color representation with a developing agent in the image forming processing to the comment portion of the PDL (PostScript) data based on the image data to be subjected to the image forming processing. The color conversion unit 203 converts colors of the image data to be subjected to the image forming processing to the colors represented in the color space used for the color representation with a developing agent in the image forming processing according to the color conversion Lut appended to the comment portion of the PDL data based on the image data to be subjected to the image forming processing in the step of setting the color space.

As has been described, according to this embodiment, by describing the multidimensional Lut (color conversion table) in the comment sentence in the PDL, it is possible to reflect the content of this look-up table on the print processing, which enables the device color to be printed in the most appropriate colors. In addition, the same PDL data can be printed without causing any error also in an image forming apparatus that supports normal PostScript.

### Fourth Embodiment

A fourth embodiment of the invention will now be described.

An image forming apparatus of the fourth embodiment is characterized in that a color conversion table for the multidimensional Lut color conversion of the device color is read in the image forming apparatus in the form of a file in the ICC profile format before the printing.

The configuration and the processing flow during the image forming processing of the fourth embodiment are the same as those of the first embodiment. This embodiment is different from the first embodiment in that the color conversion table for the multidimensional Lut color conversion processing is downloaded in the form of an ICC profile before the print processing.

The image forming apparatus receives data in the form of the ICC profile including the multidimensional Lut used in the color conversion processing, and converts the color conversion table included in this file to the format that is read in for the multidimensional Lut color conversion beforehand. Thereafter, the multidimensional color conversion table thus converted is set as the color conversion table used for the multidimensional Lut color conversion, and the color conversion unit 203 uses the multidimensional Lut thus converted in the color conversion of the device color.

According to this embodiment, the user is able to reflect the multidimensional Lut of the device color to the image forming apparatus in the form of the ICC profile. Because the ICC profile is a file format of an open specification, it is customizable by the user with ease.

### Fifth Embodiment

A fifth embodiment of the invention will now be described.

An image forming apparatus of the fifth embodiment is characterized in that the color conversion table included in the color conversion table set by a setcolorrendering operator is reflected on the color conversion of the device color.

The configuration of the fifth embodiment is the same as that of the first embodiment except that part of the processing in the image forming processing is different. In the image forming processing flow, the color conversion processing of the device color per se using the multidimensional Lut is the same as that of the first embodiment and a portion to read in the multidimensional Lut is different.

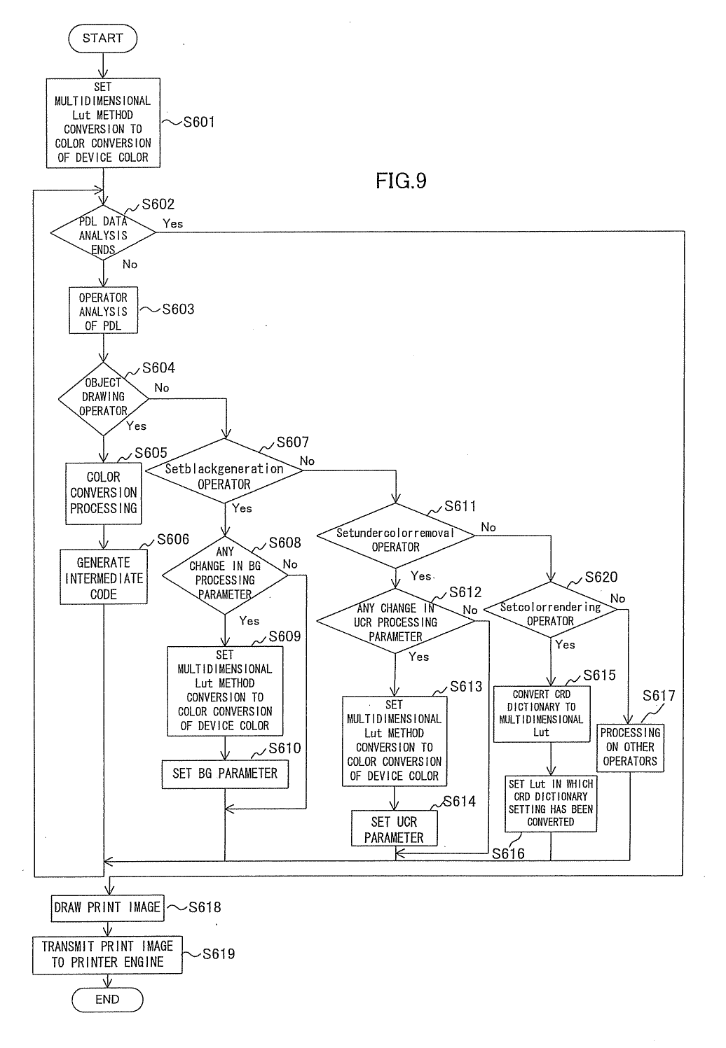

FIG. 9 is a flowchart used to describe the flow of the color conversion processing in the image forming apparatus of this embodiment. Hereinafter, descriptions will be given by focusing particularly on the read-in of the multidimensional Lut. In the flowchart shown in FIG. 9, because the processing in S601 and S602, S604 through S614, and S617 through S619 is the same as the processing in S101 and S102, S104 through S114, and S115 through S117 in the first embodiment above, descriptions are omitted herein.

In the processing flow, the color space determination unit 201 performs operator analysis of PDL data including the description that sets CRD data in compliance with the PostScript specification using the setcolorrendering operator (S603), and determines whether the operator as the subject of the processing is the setcolorrendering operator that reflects the color conversion dictionary on the color conversion to be set (S620). In a case where it is determined as being the setcolorrendering operator (S620, Yes), the content of the CRD (Color Rendering Dictionary) is converted to the multidimensional Lut (S615). Subsequently, the multidimensional Lut converted herein is set to the color conversion of the device color, and the CRD dictionary is set to the color conversion of the XYZ color space (S616). To be more specific, regarding the PDL analysis processing, the multidimensional table of the CRD set by the setcolorrendering operator is set by being converted to a table of an input color space available for the multidimensional Lut color conversion.

As has been described, according to this embodiment, it is possible to reflect the content of the color conversion dictionary set by setcolorrendering on the color conversion of the device color.

### Sixth Embodiment

A sixth embodiment of the invention will now be described.

An image forming apparatus of the sixth embodiment is characterized in that the multidimensional color conversion table set by the setcolorrendering operator can be set to the color conversion processing of the device color at higher speed.

The configuration of this embodiment is the same as the first embodiment except that part of the processing in the image forming processing is different. The processing in this embodiment and the processing in the first embodiment are the same in the color conversion processing of the device color per se using the multidimensional Lut, but different in the processing to read in the multidimensional Lut.

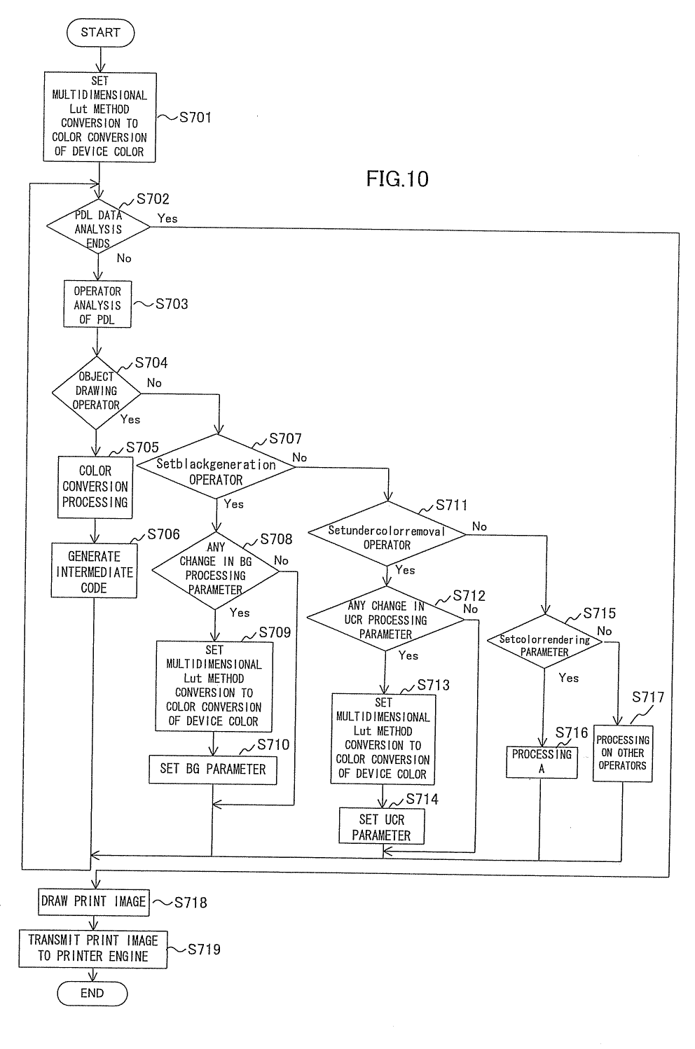

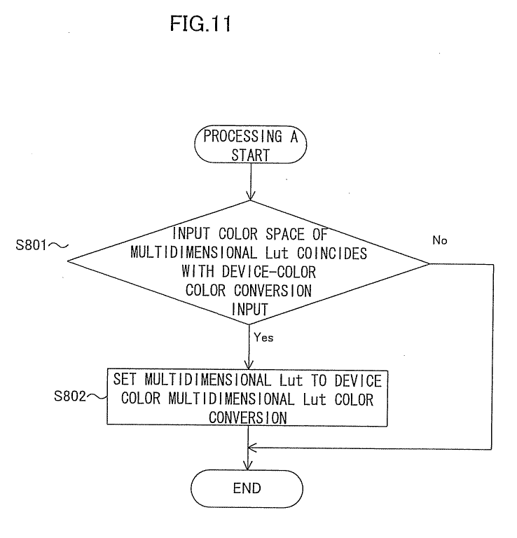

FIG. 10 and FIG. 11 are flowcharts used to describe the flow of the color conversion processing in the image forming apparatus of this embodiment. Hereinafter, descriptions will be given by focusing particularly on the read-in of the multidimensional Lut. In the flowchart shown in FIG. 10, because the processing in S701 and S702, S704 through S714, and S717 through S719 is the same as the processing in S101 and S102, S104 through S114, and S115 through S117 in the first embodiment above, descriptions are omitted herein.

The color space determination unit 201 performs the operator analysis of PDL data (S703) and determines whether the operator as the subject of the processing is the setcolorrendering operator that reflects the color conversion dictionary on the color conversion to be set. In a case where the color space determination unit 201 determines that the operator is the setcolorrendering operator (S715, Yes), it proceeds to the next processing (S716) and determines whether the input color space of the multidimensional Lut included in the color conversion dictionary coincides with the input color space of the device-color color conversion (S801). Only when the coincidence is determined, the color space setting unit 202 sets the multidimensional Lut included in the color conversion dictionary as a table of the multidimensional Lut color conversion of the device color (S802).

### Seventh Embodiment

A seventh embodiment of the invention will now be described.

An image forming apparatus of the seventh embodiment is characterized in that the multidimensional Lut determination processing performed in the sixth embodiment is performed at high speeds by utilizing the entry in the CRD dictionary.

In this embodiment, an identifier capable of identifying the input color space of the multidimensional Lut is described in the CRD dictionary. Color spaces, such as sRGB, Lab, and XYZ, are the corresponding color space.

This keyword is searched for during the analysis processing of the setcolorrendering operator to determine whether the color space is the one same as the multidimensional Lut of the device color. When they are the same, the setting is performed as a table of the multidimensional Lut processing of the device color. Meanwhile, when they are different, the setting as the table of the multidimensional Lut processing of the device color is not performed.

As has been described, in a case where PDL data including the description that sets the CRD data in compliance with the PostScript specification by the setcolorrendering operator is received, in the PDL analysis processing, whether the multidimensional LUT of CRD set by the setcolorrendering operator is the table of the input color space available for the multidimensional Lut color conversion is determined. The multidimensional Lut in the CRD is set as the table of the multidimensional Lut color conversion when the input value of the multidimensional Lut in the CRD set by the setcolorrendering operator is the same as the input color space of the multidimensional Lut color conversion processing.

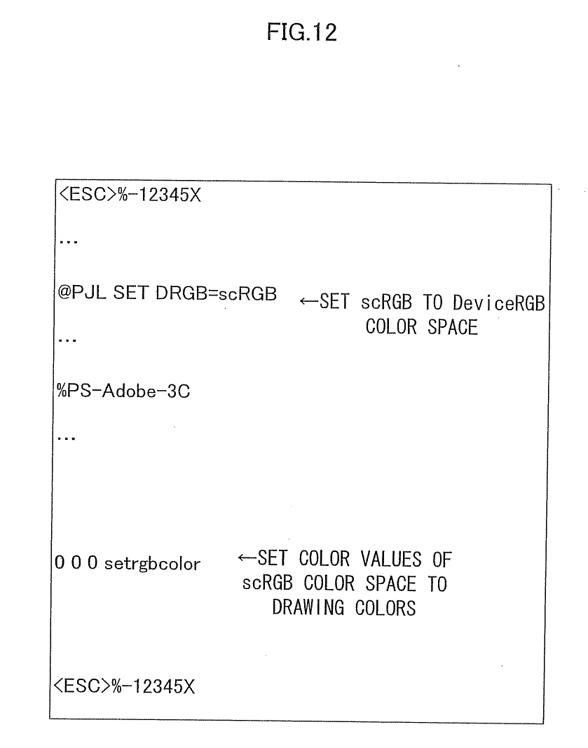

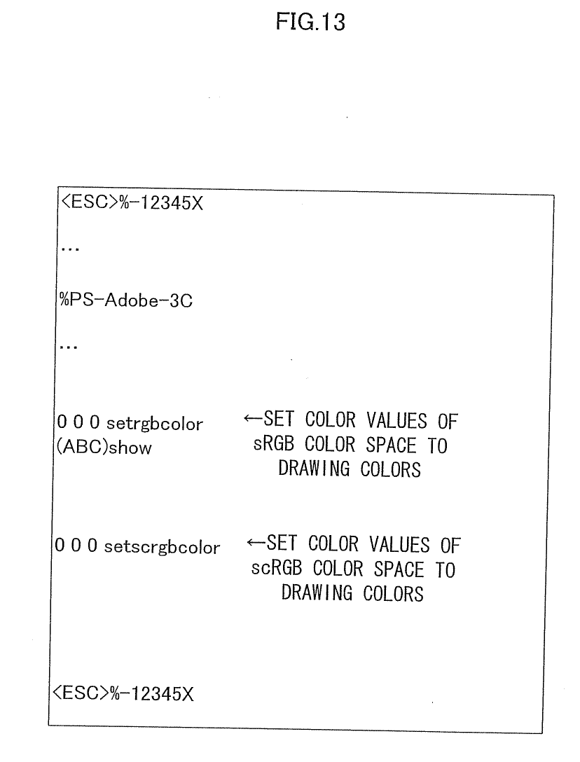

The embodiment above described a case where the color space determined by the color space determination unit 201 is appended to the comment portion of the PDL data as DeviceRGB by the color space setting unit 202 (see FIG. 12). The invention, however, is not limited to this configuration. For example, as is shown in FIG. 13, in the step of setting the color space, it may be configured in such a manner that drawing colors in the page description language data based on the image data to be subjected to the image forming processing are set in the representation system by the color space determined in the step of determining the color space. In this case, the color conversion unit 203 converts colors of the image data to be subjected to the image forming processing to colors represented in the color space used for the color representation with a developing agent in the image forming processing according to the multidimensional look-up table or a conversion matrix corresponding to the color space set as the device color space by the color space setting unit.

According to the respective embodiments described above, it is possible to configure in such a manner that the color conversion according to the polynomial device color space in compliance with the PostScript 3 languages specification and the color conversion according to the multidimensional Lut Devece color space can be executed by being switched with each other. It is possible to configure in such a manner that the multidimensional color conversion Lut used in this case can be inputted from the outside of the image forming apparatus.

The embodiment described a case where the capability to implement the invention is pre-recorded in the apparatus. The invention, however, is not limited to this configuration, and the same capability may be downloaded to the apparatus from the network or the same capability stored in a recording medium may be installed in the apparatus. The recording medium can be a recording medium of any format, such as a CD-ROM, as long as it is capable of storing the programs and readable by the apparatus. The capabilities obtained by pre-installment or downloading as described above may be those achieved in cooperation with the OS (Operating System) in the apparatus or the like.

As has been described, according to the respective embodiments above, in an image forming apparatus capable of printing PostScript data, it is possible to customize colors of the drawing object in the print document whose colors are specified to the device-color colors more flexibly, which in turn enables printing in most appropriate colors.

While the invention has been described in detail by way of particular embodiments, it is obvious to anyone skilled in the art that various modifications and alterations are possible without deviating from the sprit and the scope of the invention.

As has been described in detail, according to the invention, it is possible to provide a technique that enables high-quality image forming processing regardless of the type of color space in which the colors of image data are represented without increasing a processing burden markedly.

What is claimed is:

1. An image forming apparatus, comprising:
a color space determination unit configured to determine in which one of plural specific color spaces in representation systems different from one another colors of image data to be subjected to image forming processing are represented;
a color space setting unit configured to set the color space determined by the color space determination unit as a device color space of image data inputted into the image forming apparatus; and
a color conversion unit configured to convert the colors of the image data to be subjected to the image forming processing to colors represented in a color space used for color representation with a developing agent in the image forming processing according to the color space set as the device color space by the color space setting unit.

2. The image forming apparatus according to claim 1, wherein:
the device color space is DeviceRGB dependent on a device used to input the image data to the image forming apparatus, and the plural specific color spaces include at least sRGB and scRGB.

3. The image forming apparatus according to claim 1, wherein:
the color space setting unit appends information about the color space determined by the color space determination unit to page description language data based on the image data to be subjected to the image forming processing so as to set the color space as the device color space of the image data inputted into the image forming apparatus.

4. The image forming apparatus according to claim 3, wherein:
the color space setting unit appends a color conversion look-up table to convert colors represented in the color space determined by the color space determination unit to the colors represented in the color space used for the color representation with the developing agent in the image forming processing to a comment portion of the page description language data based on the image data to be subjected to the image forming processing.

5. The image forming apparatus according to claim 4, wherein:
the color conversion unit converts the colors of the image data to be subjected to the image forming processing to the colors represented in the color space used for the color representation with the developing agent in the image forming processing according to the color conversion look-up table appended to the comment portion of the page description language data based on the image data to be subjected to the image forming processing by the color space setting unit.

6. The image forming apparatus according to claim 3, wherein:
the color space setting unit sets drawing colors in the page description language data based on the image data to be subjected to the image forming processing to a representation system of the color space determined by the color space determination unit.

7. The image forming apparatus according to claim 1, wherein:
the color conversion unit converts the colors of the image data to be subjected to the image forming processing to the colors represented in the color space used for the color representation with the developing agent in the image forming processing according to one of a multidimensional look-up table and a conversion matrix corresponding to the color space set as the device color space by the color space setting unit.

8. A color conversion method in an image forming apparatus, comprising the steps of:
determining in which one of plural specific color spaces in representation systems different from one another colors of image data to be subjected to image forming processing are represented;
setting the color space determined in the step of determining the color space as a device color space of image data inputted into the image forming apparatus; and
converting the colors of the image data to be subjected to the image forming processing to colors represented in a color space used for color representation with a developing agent in the image forming processing according to the color space set as the device color space in the color space setting unit.

9. The color conversion method according to claim 8, wherein:
the device color space is DeviceRGB dependent on a device used to input the image data to the image forming apparatus, and the plural specific color spaces include at least sRGB and scRGB.

10. The color conversion method according to claim 8, wherein:
in the step of setting the color space, information about the color space determined in the step of determining the color space is appended to page description language data based on the image data to be subjected to the image forming processing so as to set the color space as the device color space of the image data inputted into the image forming apparatus.

11. The color conversion method according to claim 10, wherein:
in the step of setting the color space, a color conversion look-up table to convert colors represented in the color space determined in the step of determining the color space to the colors represented in the color space used for the color representation with the developing agent in the image forming processing is appended to a comment portion of the page description language data based on the image data to be subjected to the image forming processing.

12. The color conversion method according to claim 11, wherein:
in the step of converting the colors, the colors of the image data to be subjected to the image forming processing are converted to the colors represented in the color space used for the color representation with the developing agent in the image forming processing according to the color conversion look-up table appended to the comment portion of the page description language data based on the image data to be subjected to the image forming processing in the step of setting the color space.

13. The color conversion method according to claim 10, wherein:
in the step of setting the color space, drawing colors in the page description language data based on the image data to be subjected to the image forming processing are set to a representation system of the color space determined in the step of determining the color space.

14. The color conversion method according to claim 8, wherein:
the color conversion unit converts the colors of the image data to be subjected to the image forming processing to the colors represented in the color space used for color representation with the developing agent in the image forming processing according to one of a multidimensional look-up table and a conversion matrix corresponding to the color space set as the device color space by the color space setting unit.

15. A color conversion program that causes a computer to perform color conversion processing in an image forming apparatus, causing the computer to perform the steps of:
determining in which one of plural specific color spaces in representation systems different from one another colors of image data to be subjected to image forming processing are represented;
setting the color space determined in the step of determining the color space as a device color space of image data inputted into the image forming apparatus; and
converting the colors of the image data to be subjected to the image forming processing to colors represented in a color space used for color representation with a developing agent in the image forming processing according to the color space set as the device color space by the color space setting unit.

16. The color conversion program according to claim 15, wherein:
the device color space is DeviceRGB dependent on a device used to input the image data to the image forming apparatus, and the plural specific color spaces include at least sRGB and scRGB.

17. The color conversion program according to claim 15, wherein:
in the step of setting the color space, information about the color space determined in the step of determining the color space is appended to page description language data based on the image data to be subjected to the image forming processing so as to set the color space as the device color space of the image data inputted into the image forming apparatus.

18. The color conversion program according to claim 17, wherein:
in the step of setting the color space, a color conversion look-up table to convert colors represented in the color space determined in the step of determining the color space to the colors represented in the color space used for the color representation with the developing agent in the image forming processing is appended to a comment portion of the page description language data based on the image data to be subjected to the image forming processing.

19. The color conversion program according to claim 18, wherein:
in the step of converting the colors, the colors of the image data to be subjected to the image forming processing are converted to the colors represented in the color space used for the color representation with the developing agent in the image forming processing according to the color conversion look-up table appended to the comment portion of the page description language data based on the image data to be subjected to the image forming processing in the step of setting the color space.

20. The color conversion program according to claim 17, wherein:
in the step of setting the color space, drawing colors in the page description language data based on the image data to be subjected to the image forming processing are set to a representation system of the color space determined by the step of determining the color space.
